(19) United States
(12) Patent Application Publication
(10) Pub. No.: US 2022/0390607 A1
(43) Pub. Date: Dec. 8, 2022

(54) COLLABORATIVE ESTIMATION AND CORRECTION OF LIDAR BORESIGHT ALIGNMENT ERROR AND HOST VEHICLE LOCALIZATION ERROR

(71) Applicant: GM Global Technology Operations LLC, Detroit, MI (US)

(72) Inventors: Xinyu Du, Oakland Township, MI (US); Yao Hu, Sterling Heights, MI (US); Wende Zhang, Birmingham, MI (US); Hao Yu, Troy, MI (US)

(21) Appl. No.: 17/339,626

(22) Filed: Jun. 4, 2021

(51) Int. Cl. G01S 17/89; G01S 17/86; G01S 17/42; G01S 17/58; G01S 19/48; G01S 19/53; G01S 19/40

(52) U.S. Cl. CPC G01S 17/89; G01S 17/86; G01S 17/42; G01S 17/58; G01S 19/485; G01S 19/53; G01S 19/40

(57) ABSTRACT

A LIDAR-to-vehicle alignment system includes a memory and an autonomous driving module. The memory stores points of data provided based on an output of a LIDAR sensor and GPS locations. The autonomous driving module performs an alignment process including performing feature extraction on the points of data to detect one or more features of one or more predetermined types of objects having one or more predetermined characteristics. The features are determined to correspond to one or more targets because the features have the predetermined characteristics. One or more of the GPS locations are of the targets. The alignment process further includes: determining ground-truth positions of the features; correcting the GPS locations based on the ground-truth positions; calculating a LIDAR-to-vehicle transform based on the corrected GPS locations; and based on results of the alignment process, determining whether one or more alignment conditions are satisfied.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle object detection systems, and more particularly to vehicle light detection and ranging (LIDAR) systems.

Vehicles can include various sensors for detecting a surrounding environment and objects in that environment. The sensors may include cameras, radio detection and ranging (RADAR) sensors, LIDAR sensors, etc. A vehicle controller can, in response to the detected surroundings, perform various operations. The operations can include performing partial and/or fully autonomous vehicle operations, collision avoidance operations, and informational reporting operations. The accuracy of the performed operations can be based on the accuracy of the data collected from the sensors.

### SUMMARY

A LIDAR-to-vehicle alignment system is provided and includes a memory and an autonomous driving module. The memory is configured to store points of data provided based on an output of a LIDAR sensor and global positioning system locations. The autonomous driving module is configured to perform an alignment process including: obtaining the points of data; performing feature extraction on the points of data to detect one or more features of one or more predetermined types of objects having one or more predetermined characteristics, where the one or more features are determined to correspond to one or more targets because the one or more features have the one or more predetermined characteristics, and where one or more of the global positioning system locations are of the one or more targets; determining ground-truth positions of the one or more features; correcting the one or more of the global positioning system locations based on the ground-truth positions; calculating a LIDAR-to-vehicle transform based on the corrected one or more of the global positioning system locations; based on results of the alignment process, determining whether one or more alignment conditions are satisfied; and in response to the LIDAR-to-vehicle transform not satisfying the one or more alignment conditions, recalibrating at least one of the LIDAR-to-vehicle transform or recalibrating the LIDAR sensor.

In other features, the autonomous driving module is configured to, while performing feature extraction, detect at least one of (i) a first object of a first predetermined type, (ii) a second object of a second predetermined type, or (ii) a third object of a third predetermined type. The first predetermined type is a traffic sign. The second predetermined type is a light pole. The third predetermined type is a building.

In other features, the autonomous driving module is configured to, while performing feature extraction, detect an edge or a planar surface of the third object.

In other features, the autonomous driving module is configured to operate in an offline mode while performing the alignment process.

In other features, the autonomous driving module is configured to operate in an online mode while performing the alignment process.

In other features, the autonomous driving module is configured to, while performing feature extraction: convert data from the LIDAR sensor to a vehicle coordinate system and then to a world coordinate system; and aggregate resulting world coordinate system data to provide the points of data.

In other features, the autonomous driving module is configured to, while determining the ground-truth positions: based on a vehicle speed, a type of acceleration maneuverer, and a global positioning system signal strength, assign weights to the points of data to indicate confidence levels in the points of data; remove ones of the points of data having weight values less than a predetermined weight; and determining a model of a feature corresponding to remaining ones of the points of data to generate the ground-truth data.

In other features, the model is of a plane or a line.

In other features, the ground-truth data includes the model, an eigenvector, and a mean vector.

In other features, the ground-truth data is determined using principal component analysis.

In other features, the LIDAR-to-vehicle alignment system is implemented at a vehicle. The memory stores inertial measurement data. The autonomous driving module is configured to, during the alignment process: based on the inertial measurement data, determine an orientation of the vehicle; and correct the orientation based on the ground-truth data.

In other features, the autonomous driving module is configured to perform interpolation to correct the one or more of the global positioning system locations based on previously determined corrected global positioning system locations.

In other features, the autonomous driving module is configured to: correct the one or more global positioning system locations using a ground-truth model for a traffic sign or a light pole; project LIDAR points for the traffic sign or the light pole to a plane or a line; calculating an average global positioning system offset for multiple timestamps; apply the average global position system offset to provide the corrected one or more of the global positioning system locations; and update a vehicle-to-world transform based on the corrected one or more of the global positioning system locations.

In other features, the autonomous driving module is configured to: correct the one or more global positioning system locations and inertial measurement data using ground-truth point matching including running a iterative closest point algorithm to find a transformation between current data and the ground-truth data, calculating an average global positioning system offset and a vehicle orientation offset for multiple timestamps, and applying the average global positioning system offset and the vehicle orientation offset to generate the corrected one or more of the global positioning system locations and a corrected vehicle orientation; and update a vehicle-to-world transform based on the corrected one or more of the global positioning system locations and the corrected inertial measurement data.

In other features, a LIDAR-to-vehicle alignment process is provided and includes: obtaining points of data provided based on an output of a LIDAR sensor; performing feature extraction on the points of data to detect one or more features of one or more predetermined types of objects having one or more predetermined characteristics, where the one or more features are determined to correspond to one or more targets because the one or more features have the one or more predetermined characteristics; determining ground-truth positions of the one or more features; correcting one or more global positioning system locations of the one or more targets based on the ground-truth positions; calculating a LIDAR-to-vehicle transform based on the corrected one or more global positioning system locations; based on results of the alignment process, determining whether one or more alignment conditions are satisfied; and in response to the LIDAR-to-vehicle transform not satisfying the one or more alignment conditions, recalibrating at least one of the LIDAR-to-vehicle transform or recalibrating the LIDAR sensor.

In other features, the LIDAR-to-vehicle alignment process further includes, while determining the ground-truth positions: based on a vehicle speed, a type of acceleration maneuverer and a global positioning system signal strength, assigning weights to the points of data to indicate confidence levels in the points of data; removing ones of the points of data having weight values less than a predetermined weight; and determining a model of a feature corresponding to remaining ones of the points of data using principal component analysis to generate the ground truth-data, where the model is of a plane or a line, where the ground-truth data includes the model, an eigenvector, and a mean vector.

In other features, the LIDAR-to-vehicle alignment process further includes: based on inertial measurement data, determine an orientation of a vehicle; and correct the orientation based on the ground-truth data.

In other features, the one or more global positioning system locations are corrected by implementing interpolation based on previously determined corrected global positioning system locations.

In other features, the LIDAR-to-vehicle alignment process further includes: correcting the one or more global positioning system locations using a ground-truth model for a traffic sign or a light pole; projecting LIDAR points for the traffic sign or the light pole to a plane or a line; calculating an average global positioning system offset for multiple timestamps; applying the average global position system offset to provide the corrected one or more global positioning system locations; and updating a vehicle-to-world transform based on the corrected one or more global positioning system locations.

In other features, the LIDAR-to-vehicle alignment process further includes: correcting the one or more global positioning system locations and inertial measurement data using ground-truth point matching including running a iterative closest point algorithm to find a transformation between current data and the ground-truth data, calculating an average global positioning system offset and a vehicle orientation offset for multiple timestamps, and applying the average global positioning system offset and the vehicle orientation offset to generate the corrected one or more global positioning system locations and a corrected vehicle orientation; and updating a vehicle-to-world transform based on the corrected one or more global positioning system locations and the corrected inertial measurement data.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system including a sensor alignment and fusion module and a mapping and localization module in accordance with the present disclosure;

FIG. 2 is a functional block diagram of an example alignment system including an autonomous driving module performing global positioning system (GPS), LIDAR and vehicle localization correction in accordance with the present disclosure;

FIG. 3 illustrates an example alignment method including GPS, LIDAR and vehicle localization correction in accordance with the present disclosure;

FIG. 4 illustrates an example portion of the alignment method of FIG. 3 implemented while operating in an offline mode in accordance with the present disclosure;

FIG. 5 illustrates an example portion of the alignment method of FIG. 3 implemented while operating in an online mode with or without cloud-based network support in accordance with the present disclosure;

FIG. 6 illustrates an example feature data extraction method in accordance with the present disclosure;

FIG. 7 illustrates an example ground-truth data generation method in accordance with the present disclosure;

FIG. 8 illustrates an example GPS and inertial measurement correction and LIDAR-to-vehicle alignment method in accordance with the present disclosure;

FIG. 9 illustrates an example GPS correction method using a ground-truth model in accordance with the present disclosure; and

FIG. 10 illustrates an example GPS and inertial measurement correction method using ground-truth point matching in accordance with the present disclosure.

In the drawings, reference numbers may be reused to identify similar and/or identical elements.

### DETAILED DESCRIPTION

An autonomous driving module may perform sensor alignment and fusion operations, perception and localization operations, and path planning and vehicle control operations. The stated operations may be performed based on data collected from various sensors, such as LIDAR sensors, RADAR sensors, cameras, and an inertial measurement sensor (or inertial measurement unit), and data collected from a global positioning system (GPS). Sensor alignment and fusion may include alignment of a coordinate system of each sensor with a reference coordinate system, such as a vehicle coordinate system. Fusion may refer to the collecting and combining of the data from the various sensors.

Perception refers to the monitoring of vehicle surroundings and the detection and identification of various features and/or objects in the surroundings. This can include determining various aspects of the features and objects. The term “feature” as used herein refers to one or more detected points that can be reliably used to determine a location of an object. This is unlike other data points detected, which do not provide reliable information regarding location of an object, for example, a point on a leaf or branch of a tree. The aspects determined may include object distances, locations, sizes, shapes, orientation, trajectories, etc. This may include determining the type of object detected, for example, whether the object is a traffic sign, a vehicle, a pole, a pedestrian, a ground surface, etc. Lane marking information may also be detected. A feature may refer to a surface, edge, or corner of a building. Localization refers to information determined about a host vehicle, such as location, speed, heading, etc. Path planning and vehicle control (e.g., braking, steering, and accelerating) are performed based on the gathered perception and localization information.

A vehicle may include multiple LIDAR sensors. LIDAR sensor alignment including LIDAR-to-vehicle alignment and LIDAR-to-LIDAR alignment affects accuracy of determined perception and localization information including feature and object information, such as that described above. GPS measurements are used for vehicle localization, mapping and LIDAR alignment. The GPS signal can be degraded and result in blurred images of an environment, especially when the corresponding vehicle is close to large (or tall) buildings, under a bridge, or inside a tunnel, where GPS signals can be blocked. This is referred to as a multi-path effect on GPS signals. Highly accurate GPSs (e.g., a real-time kinematic GPS) can also experience this same issue. A real-time kinematic GPS uses carrier-based positioning. The degradation can result in, for example, a stationary object appearing as if the object is moving. For example, a traffic sign may appear to be moving when in actuality it is stationary. Inaccurate GPS data results negatively impact accuracy and quality of aggregated LIDAR data of a vehicle location and orientation, which is estimated based on GPS and inertial measurements.

The examples set forth herein include estimating LIDAR boresight alignment and correcting host vehicle location using LIDAR, inertial and GPS measurements. This includes correcting GPS data and vehicle orientation. The examples include a collaborative framework iteratively implementing a process to generate accurate vehicle locations and provide accurate LIDAR boresight alignment. The iterative process corrects GPS data while performing LIDAR calibration. GPS and inertial measurement signal data are corrected based on LIDAR data associated with multiple features. Data of explicit and/or selected road elements (e.g., traffic signs and light poles) is used to determine a ground-truth. A “ground-truth” refers to points and/or information that are known to be correct, which may then be used as a reference based on which information is generated and/or decisions are made. Principal component analysis (PCA) is used to characterize features. Corrected location information is used to calibrate vehicle-to-LIDAR alignment. Feature data from past travel history of the host vehicle and/or other vehicles is used to improve algorithm performance.

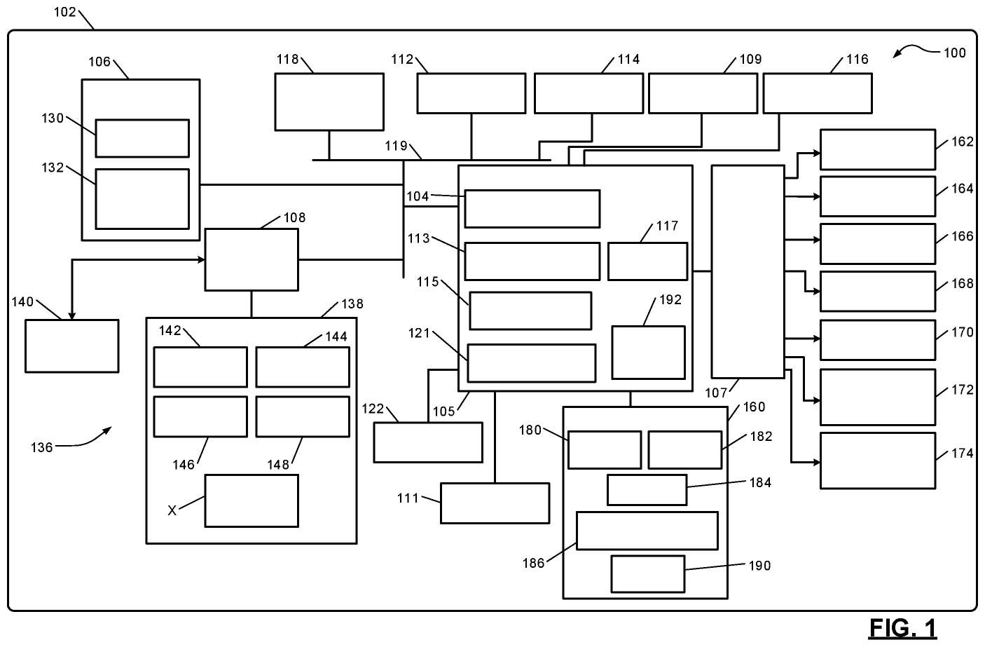

FIG. 1 shows an example vehicle system 100 of a vehicle 102 including a sensor alignment and fusion module 104 and a mapping and localization module 113. Operations performed by the module 104 and 113 are further described below with respect to FIGS. 1-10.

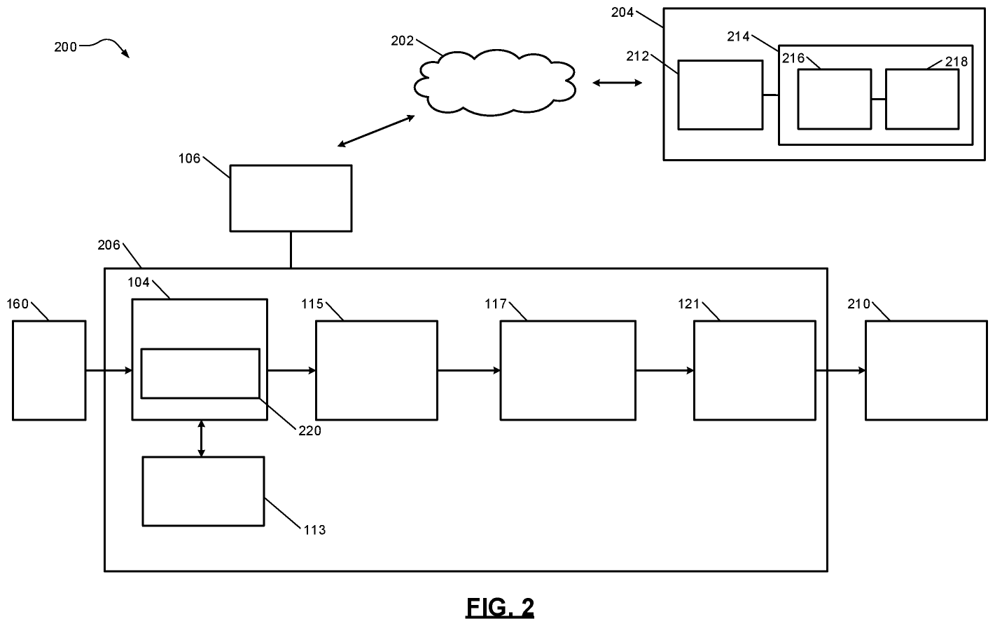

The vehicle system 100 may include an autonomous driving module 105, a body control module (BCM) 107, a telematics module 106, a propulsion control module 108, a power steering system 109, a brake system 111, a navigation system 112, an infotainment system 114, an air-conditioning system 116, and other vehicle systems and modules 118. The autonomous driving module 105 includes the sensor alignment and fusion module 104 and the mapping and localization module 113 and may also include an alignment validation module 115, a perception module 117, and a path planning module 121. The sensor alignment and fusion module 104 and the mapping and localization module 113 may be in communication with each other and/or implemented as a single module. The mapping and localization module 113 may include a GPS correction module, as shown in FIG. 2. Operations of these modules are further described below.

The modules and systems 104-108, 112-115, 121 and 118 may communicate with each other via a controller area network (CAN) bus, a Ethernet network, a local interconnect network (LIN) bus, another bus or communication network and/or wirelessly. Item 119 may refer to and/or include a CAN bus, an Ethernet network, a LIN bus and/or other bus and/or communication network. This communication may include other systems, such as systems 109, 111, 116. A power source 122 may be included and power the autonomous driving module 105 and other systems, modules, devices and/or components. The power source 122 may include an accessory power module, one or more batteries, generators and/or other power sources.

The telematics module 106 may include transceivers 130 and a telematics control module 132. The propulsion control module 108 may control operation of a propulsion system 136 that may include an engine system 138 and/or one or more electric motor(s) 140. The engine system 138 may include an internal combustion engine 141, a starter motor 142 (or starter), a fuel system 144, an ignition system 146, and a throttle system 148.

The autonomous driving module 105 may control the modules and systems 106, 108, 109, 111, 112, 114, 116, 118 and other devices and systems based on data from sensors 160. The other devices and systems may include window and door actuators 162, interior lights, 164, exterior lights 166, trunk motor and lock 168, seat position motors 170, seat temperature control systems 172, and vehicle mirror motors 174. The sensors 160 may include temperature sensors, pressure sensors, flow rate sensors, position sensors, etc. The sensors 160 may include LIDAR sensors 180, RADAR sensors 182, cameras 184, inertial measurement sensor 186, a GPS system 190, and/or other environment and feature detection sensors. The GPS system 190 may be implemented as part of the navigation system 112. The LIDAR sensors 180, the inertial measurement sensor 186, and the GPS system 190 may provide the LIDAR data points, inertial measurement data and GPS data referred to below.

The autonomous driving module 105 may include memory 192, which may store sensor data, historical data, alignment information, etc. The memory 192 may include dedicated buffers, referred to below.

FIG. 2 shows an example alignment system 200 including an autonomous driving module performing global positioning system (GPS), LIDAR and vehicle localization correction. The system 200 may include a first (or host) vehicle (e.g., the vehicle 102 of FIG. 1) and/or other vehicles, a distributed communication system 202, and a back office 204. The host vehicle includes an autonomous driving module 206, which may replace and/or operate similarly as the autonomous driving module 105 of FIG. 1, the vehicles sensors 160, the telematics module 106, and actuators 210. The actuators 210 may include motors, drivers, valves, switches, etc.

The back office 204 may be a central office that provides services for the vehicles including data collection and processing services. The back office 204 may include a transceiver 212 and a server 214 with a control module 216 and memory 218. In addition or as an alternative, the vehicles may be in communication with other cloud-based network devices other than the server.

The autonomous driving module 206 may replace the autonomous driving module 105 of FIG. 1 and may include the sensor alignment and fusion module 104, the mapping and localization module 113, the alignment validation module 115, the perception module 117, and the path planning module 121.

The sensor alignment and fusion module 104 may perform sensor alignment and fusion operations, as further described below, based on outputs of the sensors 160 (e.g., the sensors 180, 182, 184, 186, 190). The mapping and localization module 113 performs operations described further below. A GPS correction module 220 may be included in one of the modules 104, 113. The alignment validation module 115 determines whether LIDAR sensors and/or other sensors are aligned, meaning differences in information provided by the LIDAR sensors and/or other sensors for the same one or more features and/or objects are within predetermined ranges of each other. The alignment validation module 115 may determine difference values for six degrees of freedom of the LIDAR sensors including roll, pitch, yaw, x, y, and z difference values and based on this information determines whether the LIDAR sensors are aligned. The x coordinate may refer to a lateral horizontal direction. The y coordinate may refer to a fore and aft or longitudinal direction, and the z direction may refer to a vertical direction. The x, y, z coordinates may be switched and/or defined differently. If not aligned, one or more of the LIDAR sensors may be recalibrated. In one embodiment, when one of the LIDAR sensors is determined to be misaligned, the misaligned LIDAR sensor is recalibrated. In another embodiment, when one of the LIDAR sensors is determined to be misaligned, two or more LIDAR sensors including the misaligned LIDAR sensor are recalibrated. In another embodiment, the misaligned LIDAR sensor is isolated and no longer used and an indication signal is generated indicating service is needed for the LIDAR sensor. Data from the misaligned sensor may be discarded. Additional data may be collected after recalibration and/or service of the misaligned LIDAR sensor.

The mapping and localization module 113 and the sensor alignment and fusion module 104 provide accurate results for GPS positions and LIDAR alignment, such that data provided to the perception module 117 is accurate for perception operations. After validation, the perception module 117 may perform perception operations based on the collected, corrected and aggregated sensor data to determine aspects of an environment surrounding a corresponding host vehicle (e.g., the vehicle 102 of FIG. 1). This may include generating perception information as stated above. This may include detection and identification of features and objects, if not already performed, and determining locations, distances, and trajectories of the features and objects relative to the host vehicle. The path planning module 121 may determine a path for the vehicle based on an output of the perception and localization module 113. The path planning module 121 may control operations of the vehicle based on the determined path including controlling operations of the power steering system, the propulsion control module, and the brake system via the actuators 210.

The autonomous driving module 206 may operate in an offline mode or an online mode. The offline mode refers to when the back office 204 collects data and performs data processing for the autonomous driving module 206. This may include, for example, collecting GPS data from the vehicle and performing GPS positioning correction and LIDAR alignment for data annotation and providing the correction GPS data and data annotation back to the autonomous driving module 206. A neural network of the autonomous driving module 206 may be trained based on the data annotation. GPS position corrections may be made prior to data annotation. Although not shown in FIG. 2, the control module 216 of the server 214 may include one or more of the modules 104, 113, and/or 115 and/or perform similar operations as one or more of the modules 104, 113 and/or 115.

During the offline mode, the server 214 is processing data previously collected over an extended period of time. During the online mode, the autonomous driving module 206 performs the GPS positioning correction and/or the LIDAR alignment. This may be implemented with or without aid of a cloud-based network device, such as the server 214. During the online mode, the autonomous driving module 206 is performing real-time GPS positioning and LIDAR alignment using collected and/or historical data. This may include data collected from other vehicles and/or infrastructure devices. The cloud-based network device may provide historical data, historical results, and/or perform other operations to aid in the real-time GPS positioning and LIDAR alignment. The real-time GPS positioning refers to providing GPS information for a current location of the host vehicle. LIDAR alignment information is generated for a current state of one or more LIDAR sensors.

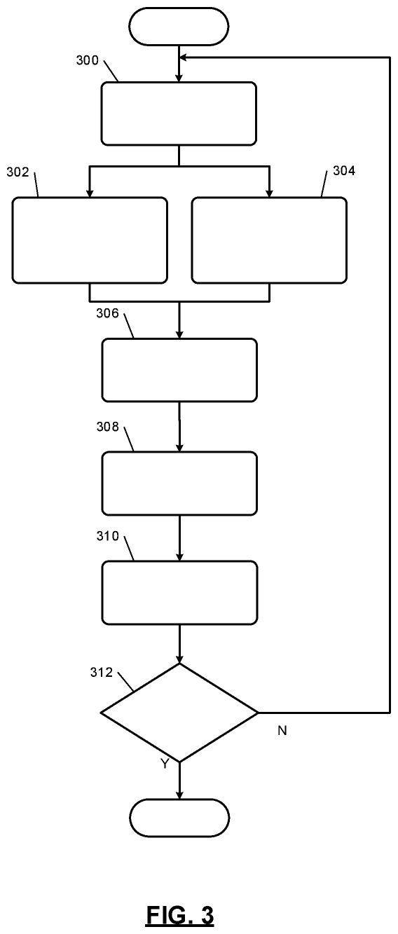

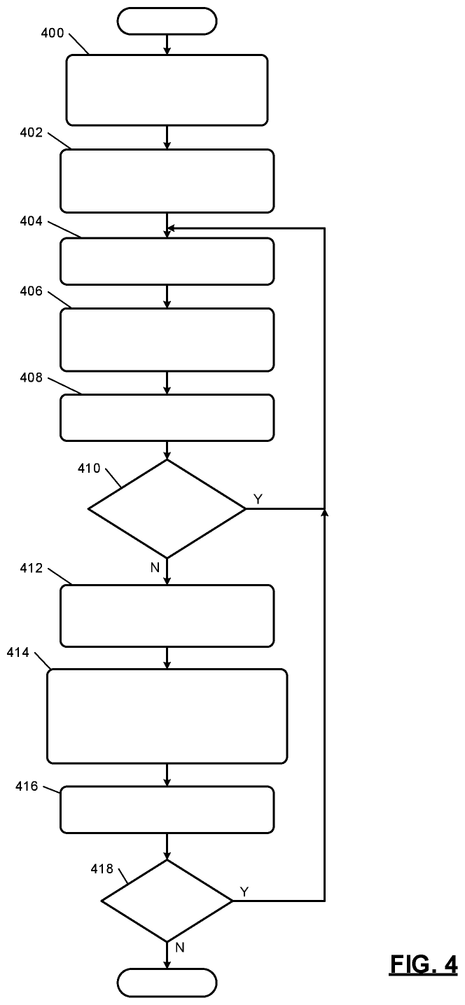

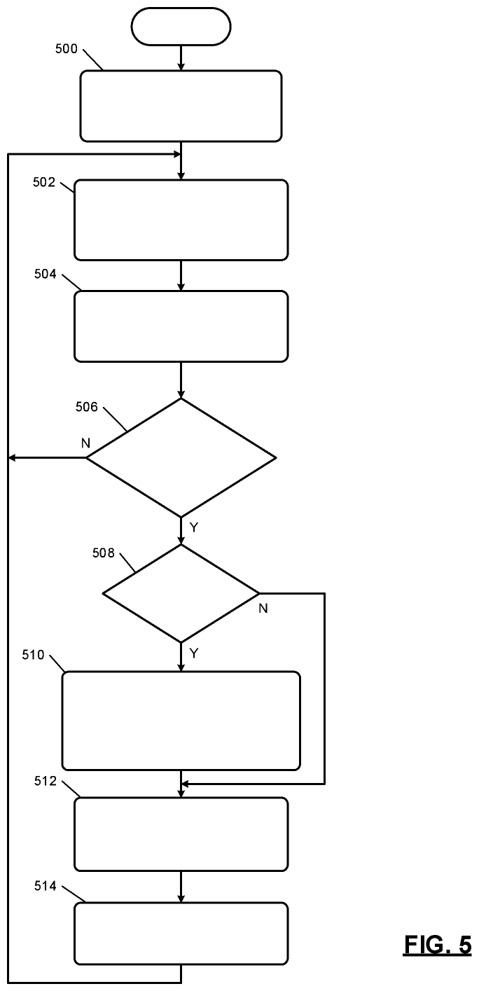

FIG. 3 shows an alignment method including GPS, LIDAR and vehicle localization correction. The operations of FIG. 3, as with the operations of FIGS. 4-5, may be performed by one or more of the modules 104, 113, 220 of FIGS. 1-2.

The alignment method is performed to calibrate LIDAR-to-vehicle boresight alignment dynamically and correct GPS and inertial measurement localization results. The method is for dynamic LIDAR calibration and GPS and inertial measurement correction. PCA and plane fitting are used to determine a ground-truth of, for example, a traffic sign location. Multi-feature fusion is performed to determine a ground-truth position data of objects, such as traffic signs and light poles. Ground-truth data for point registration may also be performed. Interpolation is used to correct GPS measurements, when a LIDAR sensor does not scan a traffic sign within a certain range of the host vehicle. The ground-truth points may be weighted to improve algorithm performance when searching for a best transformation. The ground-truth data is saved in vehicle memory and/or in cloud-based network memory and applied during upcoming trips of the host vehicle and/or other vehicles.

The method may begin at 300, which includes collecting data from sensors, such as the sensors 160 of FIG. 1. The collected GPS data includes longitude, latitude, and attitude data. Inertial measurements are taken via the inertial measurement sensor 186 for roll, pitch, yaw rate, acceleration and orientation determinations and estimates angles. At 302 and 304, feature extraction is performed. At 302, feature detection and characterization is performed for first feature types (e.g., traffic signs, light poles, etc.). At 304, other feature detection and characterization is performed for second feature types (e.g., building edges, corners, planar surface, etc.).

At 306, a ground-truth position is calculated for one or more features and/or objects. Different road elements are monitored including signs, buildings, and light poles, which provide substantial coverage and a robust system. Road elements are detected, such as traffic signs for determining a ground-truth position. This may include use of a whole point cloud from a LIDAR sensor. With prior knowledge of a traffic sign, having characteristics of a flat plane, high intensity reflectance, and being static (i.e. not moving), the algorithm implemented at 306 is able to easily characterize sign data using a PCA approach to determine the ground-truth position of the sign.

At 308, a GPS location is corrected using the one or more ground-truth positions. This may include performing interpolation to address missing LIDAR gaps in data, where LIDAR data is not available and/or not usable for certain time periods and/or timestamps. This improves localization accuracy.

At 310, the corrected GPS location is used to calculate alignment. During this operation, LIDAR-to-vehicle alignment may be recalibrated to address alignment drift.

At 312, operations may be performed to determine whether the alignment is acceptable. This may include performing an alignment validation process. The alignment validation process may include performing multiple methods. The methods include integration of ground fitting, target detection and point cloud registration. In one embodiment, roll, pitch, and yaw differences between LIDAR sensors are determined based on targets (e.g., ground, traffic sign, light pole, etc.). In a same or alternative embodiment, rotation and translation differences of LIDAR sensors are determined based differences in point cloud registrations of the LIDAR sensors.

The validation methods include (i) a first method for determining a first six parameter vector of differences between LIDAR sensors in pitch, roll, yaw, x, y, z values are determined, and/or (ii) a second method for determining a second six parameter vector of pitch, roll, yaw, x, y, z values are determined. The first method is based on selection of certain objects for determining roll, pitch and yaw. The second method is based on determining rotation and translation differences from point clouds of LIDAR sensors. The results of the methods may be weighted and aggregated to provide a resultant six parameter vector based on which a determination of alignment is made, as described above. If the results are accepted, the method may end and the GPS position information and outputs of the LIDAR sensors may be used for making autonomous driving decisions including the control of the systems 109, 111, 136, etc. Another variation is if the alignment results are accepted, the alignment algorithm is not executed, but a GPS correction algorithm is continuously run to correct GPS coordinates. Alignment results generally do not change with time, unless long term degradation and/or an accident occurs, but GPS correction results may be updated and are useful any time since the vehicle is moving (i.e. the location of the vehicle is changing). If the results are not accepted, at least one of (i) the LIDAR-to-vehicle transform may be recalibrated, and/or (ii) one or more LIDAR sensors may be recalibrated and/or serviced.

In an embodiment, the alignment validation is performed subsequent to operation 310 and validates the alignment performed at 310. In another embodiment, the alignment validation is performed prior to at least operations 308 and 310. In this embodiment, the operations of FIG. 3 are performed to perform GPS correction and to correct alignment as a result of the validation process indicating an invalid alignment.

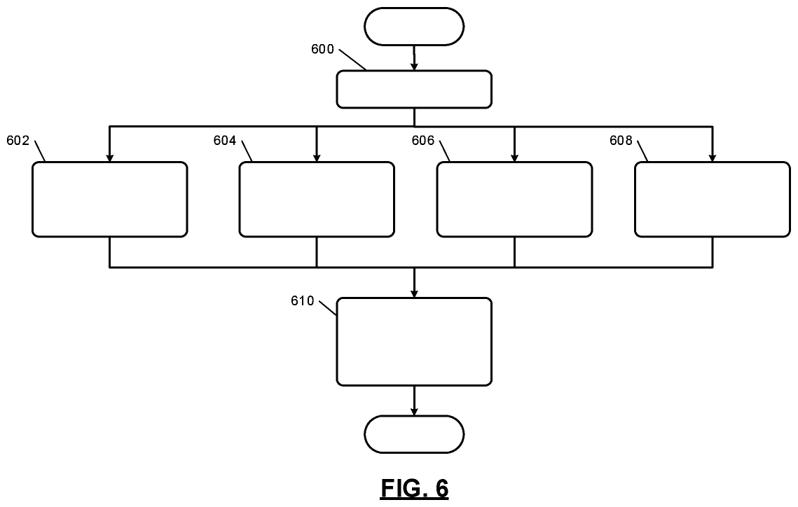

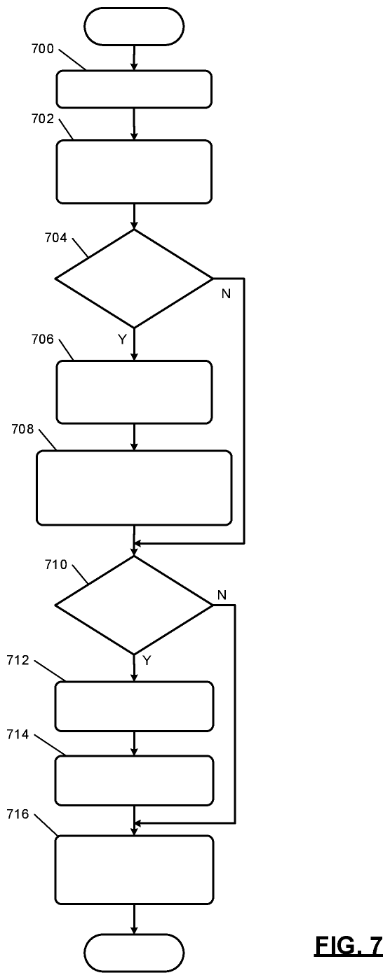

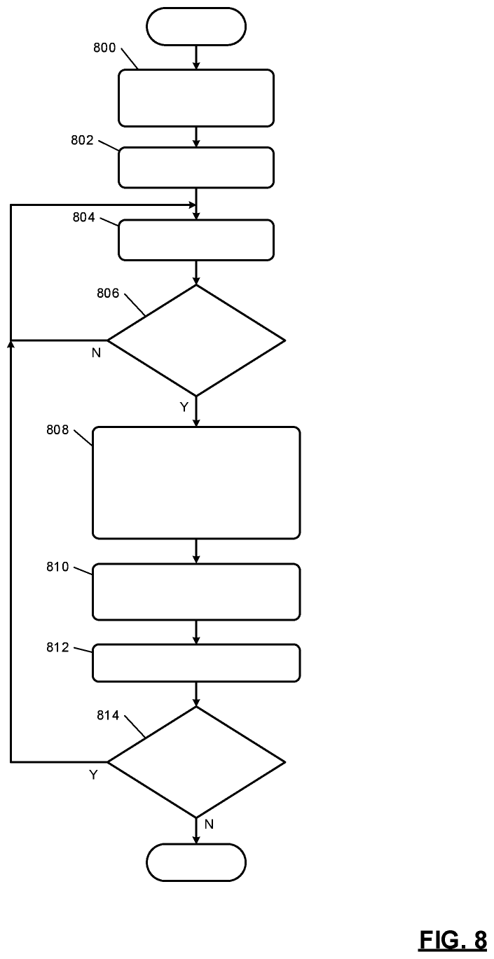

Operations 302, 306, 308 and 310 are further described below with respect to the methods of FIGS. 4-5. Operation 302 is also further described with respect to the method of FIG. 6. Operation 306 is further described with respect to the method of FIG. 7. Operations 308 and 310 are further described with respect to the methods of FIGS. 8-10.

FIG. 4 shows a portion of the alignment method of FIG. 3 implemented while operating in the offline mode. The method may begin at 400, which includes loading the latest LIDAR-to-vehicle and vehicle-to-world transforms and/or outputs of next algorithm into memory (e.g., the memory 192 of FIG. 1) of the vehicle.

At 402, the LIDAR points are converted from a LIDAR frame to a world frame using the above two transforms. The LIDAR coordinates are converted to vehicle coordinates and then converted to world coordinates (e.g., east, north, up (ENU) coordinates). A matrix transformation may be performed to convert to world coordinates. When a vehicle to world transform is performed and the resultant image generated from aggregated LIDAR data is blurred, GPS data is inaccurate. The GPS location is corrected at 414, such that after the correction, the resultant image is clear.

At 404, LIDAR points of data (referred to as LIDAR points) are continuously aggregated for a next batch. As an example, this may be done for a batch of 500 frames. At 406, feature data is extracted from the aggregated LIDAR point cloud using feature extraction method of FIG. 6. At 408, feature data is saved to dedicated buffer in the memory.

At 410, a determination is made as to whether there is data collected for a feature. If yes, operation 404 may be performed, otherwise operation 412 is performed. At 412, a ground-truth of the data is calculated using the ground-truth data generation method of FIG. 7.

At 414, the ground-truth data is used for location correction and the LIDAR-to-vehicle transform is updated. This is done based on GPS and inertial measurement corrections and by implementing the LIDAR-to-vehicle alignment method of FIG. 8. At 416, the update location data and LIDAR-to-vehicle alignment information is saved. At 418, a determination is made as to whether there is more data to be processed. If yes, operation 404 may be performed, otherwise the method may end.

In one embodiment, during the offline mode, data is reprocessed to be corrected after the data and/or other data is aggregated and the ground-truth is generated.

FIG. 5 shows a portion of the alignment method of FIG. 3 implemented while operating in an online mode with or without cloud-based network support. The method may begin at 500, which includes loading the latest LIDAR-to-vehicle and vehicle-to-world transforms and/or outputs of next algorithm into memory (e.g., the memory 192 of FIG. 1) of the vehicle.

At 502, LIDAR data is read, and the LIDAR points are converted from a LIDAR frame to a world frame using the above two transforms. The LIDAR coordinates are converted to vehicle coordinates and then converted to world coordinates (or east, north upper (ENU) coordinates). A matrix transformation may be performed to convert to world coordinates. When a vehicle-to-world transform is performed and the resultant image generated from aggregated LIDAR data is blurred, GPS data is inaccurate. The GPS location is corrected at 510, such that after the correction, the resultant image is clear.

At 504, the ground-truth data from memory and/or a cloud-based network device is loaded (or obtained) by, for example, the autonomous driving module 206 of FIG. 2. At 506, a determination is made as to whether there is potential feature using feature data extraction method of FIG. 6. If yes, operation 508 may be performed, otherwise operation 502 is performed.

At 508, a determination is made as to whether the potential feature data is part of ground-truth data. If yes, operation 510 is performed, otherwise operation 512 is performed.

At 510, the ground-truth data is used to correct the location and update the LIDAR-to-vehicle transform. This is done based on GPS and inertial measurement corrections and by implementing the LIDAR-to-vehicle alignment method of FIG. 8. At 512, the vehicle transformed data is continuously aggregated and the ground-truth is generated using the method of FIG. 7.

At 514, the ground-truth data stored in memory and/or in the cloud-based network device are updated with the ground-truth data generated at 512. Operation 502 may be performed subsequent to operation 514. The updated ground-truth data (i) is saved for a next set of data and a next or subsequent timestamp and/or time period, and (ii) is not used for the current set of data and a current timestamp and/or time period. For the online correction mode, there may not be enough time to accumulate data for ground-truth generation prior to location correction and thus is generated subsequent to the correction for a next set of data.

FIG. 6 shows an example feature data extraction method. The method may begin at 600, which includes applying a spatial filter to find static points. As an example, the static points may be at locations where z is greater than 5 meters and distance of the points from the vehicle are greater than 20 meters.

The space filter uses a 3-dimensional (3D) region in space to pick points within the region. For example, the space filter may be defined as having ranges x, y, z: x ∈ [ [symbol] ₁, ϑ₂,], y ∈[ϑ₃, ϑ₄], z ∈[ϑ₅, ϑ₆], where ϑ₁, ϑ₂, ϑ₃, ϑ₄, ϑ₅, ϑ₆ are predetermined values (or thresholds). If a point's (x,y,z) satisfies a predetermined condition of being within the region, it is selected by the space filter.

At 602, an intensity filter and a shape filter are used to detect first objects (e.g., traffic signs). A traffic sign has predetermined characteristics, such as being planar and having a certain geometrical shape. The intensity filter may include an intensity range defined to select points with intensity values that are in the intensity range (e.g., a range of 0-255). As an example, the intensity filter may select points having intensity values greater than 200. The intensity values are proportional to the reflectance of the material of the feature and/or object on which the point is located. For example, the intensity filter may be defined as i>ϑ₇, where i is intensity and ϑ₇ is a predetermined threshold. The shape filter may include detecting objects having predetermined shapes. At 604, an intensity filter and a shape filter are used to detect second objects (e.g., light poles). A light pole has predetermined characteristics, such as being long and cylindrical-shaped.

At 606, an edge detection algorithm is used to detect first features (e.g., edges of buildings). The edge detection algorithm may be a method stored in a point cloud library stored in the memory 192 of FIG. 1 or in a cloud-base network device. At 608, a plane detection algorithm is used to detect second features (e.g., planes of buildings). The plane detection algorithm may be a method stored in a point cloud library stored in the memory 192 of FIG. 1 or in a cloud-base network device.

At 610, the feature data and feature types (e.g., traffic sign, light pole, edge of building, or plane of building) are saved along with the vehicle location and orientation previously determined. The method may end subsequent to operation 610.

FIG. 7 shows an example ground-truth data generation method. The method may begin at 700, which includes loading feature data.

At 702, assigns weights to features based on parameters. For example, based on vehicle speed, the type of acceleration maneuverer being performed, the GPS signal strength, weights are assigned to traffic sign LIDAR points to indicate confidence levels of the points. If the traffic sign does not move in position from frame-to-frame, but the host vehicle position has changed, then an issue exists and the weighted values are set low for these points. If however the traffic sign does move in position from frame-to-frame in an expected manner, then higher weight values are given to the points indicating higher confidence levels in the points.

At 704, a determination is made as to whether the feature data is of the first type (e.g., a traffic sign). If yes, operation 706 is performed, otherwise operation 710 is performed.

At 706, the low weighted points are filtered out (e.g., points assigned weight values less than a predetermined weight value). At 708, principal component analysis (PCA) or plane fitting is performed after the low-weighted points are removed to determine a model of the feature. The model may be in a form of equation 1, where d=e₃×m, a=e₃₁, b=e₃₂, and c=e₃₃⁺ e₃=[e₃₁, e₃₂, e₃₃]. a and b are perpendicular eigenvectors in the plane and c is the third eigenvector that is perpendicular to the plane of the feature and is calculated from PCA. m is the mean (or average) vector of the remaining points.

ax+ by+cz=d (1)

At 710, a determination is made as to whether the feature data is of a second type (e.g., a light pole). If yes, operation 712 is performed, otherwise operation 716 is performed.

At 712, the low weighted points are filtered out. At 714, the remaining points are fit to a 3D line model as represented by equation 2, where t is a parameter, e₁ is the eigenvector corresponding to the largest eigen value from PCA, and m is the mean vector. Eigen vectors e₂ and e₃ are very small. The first eigenvector e₁ extends in a longitudinal direction of the light pole (e.g., in the z direction for a vertically extending pole).

(x,y,z)=m+t*e₁ (2)

At 716, the model generated, the data of the remaining points, and corresponding weights are saved in, for example, the memory 192 of FIG. 1.

FIG. 8 shows an example GPS and inertial measurement correction and LIDAR-to-vehicle alignment method. The method may begin at 800, which includes reading LIDAR data points and obtaining GPS and inertial measurement data.

At 802, the LIDAR data points are projected to world coordinates. At 804, the projected LIDAR data points are aggregated.

At 806, a determination is made whether there is a projected LIDAR data point in the ground-truth data range. If yes, then operation 808 is performed, otherwise operation 804 is performed.

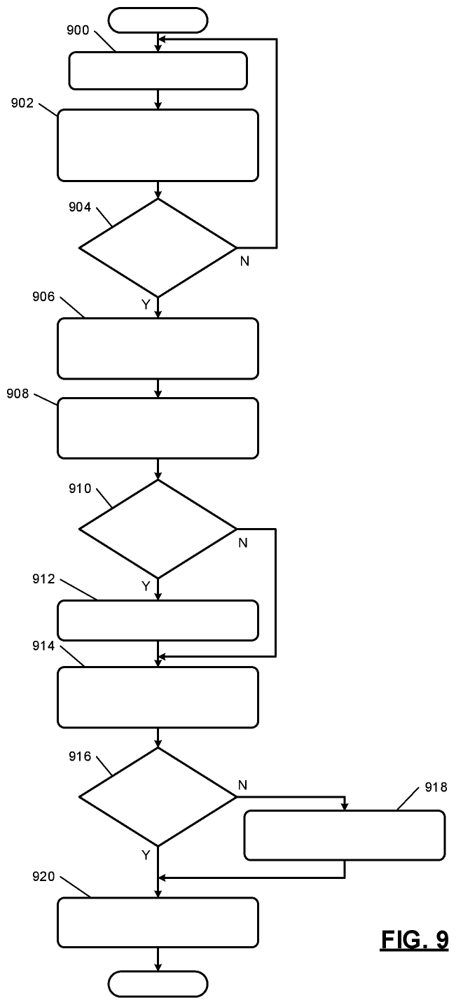

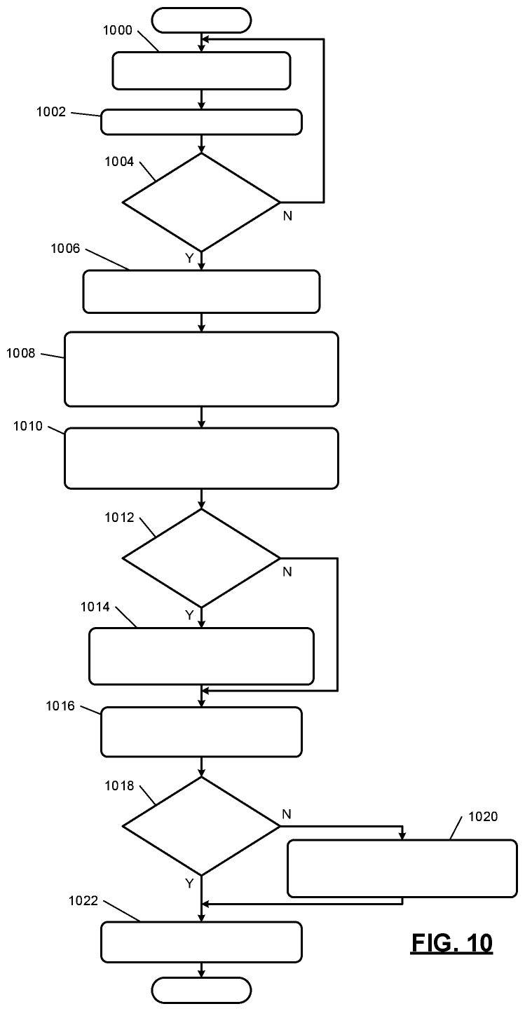

At 808, GPS and inertial measurement data is corrected using one or more of the methods of FIGS. 9-10 and the vehicle-to-world transform is updated. At 810, the corrected GPS and LIDAR data is used to calculate a LIDAR-to-vehicle transform. At 812, the LIDAR-to-vehicle transform is saved to the memory 192 of FIG. 1.

At 814, a determination is made as to whether there are more LIDAR data points. If yes, operation 804 is performed, otherwise the method may end subsequent to operation 814.

FIG. 9 shows an example GPS correction method using a ground-truth model. The method may begin at 900, which includes loading LIDAR data points and GPS and inertial measurement data.

At 902, ground-truth data is loaded for a first object (e.g., a traffic sign) or a second object (e.g., a light pole).

At 904, a determination is made as to whether there are LIDAR points belonging to one or more targets. The one or more targets may refer to, for example, one or more currently detected static objects, such as traffic signs and/or light poles. If yes, operation 906 is performed, otherwise operation 900 is performed.

At 906, LIDAR points belonging to targets are projected to a plane and/or a line. This may be done using the following equations 3-5, where X_{Lidar} is a LIDAR point having x, y and z components, X′_{Lidar} is the projected point, center is a mean vector, norm is the third eigenvector e₃, and norm^{T} is the transpose of norm. This includes removing center, projecting to the plane, and add the center back.

X′_{Lidar}=X_{Lidar}−center (3)

X′_{Lidar}=X_{Lidar}−X_{Lidar}*norm*norm^{T} (4)

X_{Lidar}=X′_{Lidar}+center (5)

At 908, an average GPS offset is calculated for each timestamp and saved to a dedicated buffer of the memory 192 of FIG. 1. A difference between the original point and the projected point is determined to provide the GPS offset.

At 910, a determination is made as to whether the corrected offset is reasonable by comparing the corrected offset with neighboring offsets on a corrected offset curve (generated based on corrected offsets). If the corrected offset is an outlier (e.g., more than a predetermined distance from the corrected offset curve), then the corrected offset is not used. If the corrected offset is on the corrected offset curve or within a predetermined distance of the corrected offset curve, then it is used. The corrected offset curve may then be updated based on the corrected offset used. If the corrected offset is used, operation 912 is performed, otherwise operation 914 is performed.

At 912, the corrected offset is applied and a correct GPS location is calculated. At 914, a timestamp for two neighboring corrected GPS locations is determined. The neighboring corrected GPS locations refer to corrected GPS locations closest in time to the GPS location to be corrected.

At 916, a determination is made as to whether a difference in time between the timestamp for the current corrected GPS location and the timestamp of the two neighboring corrected GPS locations is greater than a predetermined threshold. If no, operation 918 is performed, otherwise operation 920 is performed.

At 918, interpolation (e.g., linear interpolation) is performed to calculate a corrected GPS location for the target. If operation 912 is performed, then an average of the corrected GPS location determined at 912 may be averaged with the corrected GPS location determined at 918. At 920, the corrected GPS location and other corresponding information, such as timestamps and neighboring corrected GPS locations may be stored in the memory 192.

The method of FIG. 9 may be performed for more than one detected object (or target). A correction may be made based on ground-truth models of the objects. If multiple objects are able to be relied upon, then the process may be performed for each object. Corrected values may be provided for each object. An average of the corrected offsets for a particular timestamp may be determined and used to correct GPS locations.

FIG. 10 shows an example GPS and inertial measurement correction method using ground-truth point matching. The method of FIG. 10 may be performed instead of performing the method of FIG. 9 or may be performed in addition to and in parallel with the method of FIG. 9. The method may begin at 1000, which includes loading LIDAR data points and GPS and inertial measurement data.

At 1002, the ground-truth data is loaded. This may include the ground-truth data determined when performing the method of FIG. 7.

At 1004, a determination is made as to whether there are LIDAR points belonging to one or more targets. If yes, operation 1006 is performed, otherwise operation 1000 is performed.

At 1006, other LIDAR points that do not correspond to the one or more targets are filtered out.

At 1008, a LIDAR point cloud registration (e.g., an iterative closest point (ICP) algorithm and/or a generalized iterative closest point (GICP)) algorithm is performed to find a transformation between current data and ground-truth data. A weight may be used in an ICP and/or GICP optimization function.

ICP is an algorithm used to minimize a difference between two point clouds. ICP may include computing correspondences between two scans and computing a transformation, which minimizes distance between corresponding points. Generalized ICP is similar to ICP and may include attaching a probabilistic model to a minimization operation of ICP. The ICP algorithm may perform a rigid registration in an iterative fashion by alternating between (i) given the transformation, finding the closest point in S for every point in M, and (ii) given the correspondences, finding the best rigid transformation by solving a least squares problem. Point set registration is the process of aligning two points sets.

At 1010, an average GPS offset and a vehicle orientation offset are calculated for each timestamp and saved to a dedicated buffer in the memory 192 of FIG. 1.

At 1012, a determination is made as to whether the average GPS offset is reasonable by comparing the average GPS offset with one or more neighboring offset and orientation values. If yes, operation 1014 is performed, otherwise operation 1016 is performed.

At 1014, the average GPS offset is applied and a corrected GPS location and corrected vehicle orientation are calculated.

At 1016, a timestamp for two neighboring corrected GPS locations is determined, as similarly performed at 914 of FIG. 9.

At 1018, a determination is made as to whether a difference in time between the timestamp for the GPS location to be corrected and the timestamp of the two neighboring corrected GPS locations is greater than a predetermined threshold. If no, operation 1020 is performed, otherwise operation 1022 is performed.

At 1020, interpolation (e.g., linear interpolation) is performed to calculate a corrected GPS location and corrected vehicle orientation. If operation 1014 is performed, then (i) an average of the corrected GPS location determined at 1014 may be averaged with the corrected GPS location determined at 1020, and (ii) an average of the corrected vehicle orientation determined at 1014 may be averaged with the corrected vehicle orientation determined at 1020.

At 1022, the corrected GPS location, corrected vehicle orientation and other corresponding information, such as timestamps and neighboring corrected GPS location information may be stored in the memory 192.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The above-described examples include updating LIDAR-to-vehicle alignment using an updated location and orientation to improve LIDAR-to-vehicle alignment accuracy. GPS data is corrected using LIDAR data and specific detected features (e.g., traffic signs, light poles, etc.). This does to provide a system that is robust to initial guesses, hyper-parameters, and dynamic objects, as opposed to general point registration approaches. The Examples include feature and/or object detection and characterization using intensity and spatial filters, clustering and PCA. A flexible feature fusion architecture is provided to calculate ground truth positions of features and/or objects (e.g., lane markings, light poles, road surfaces, building surfaces, and corners) to improve overall system accuracy and robustness. GPS locations are corrected using ground truth information with interpolation to provide a system that is robust to noise data and missing frames. As a result accurate LIDAR boresight alignment and accurate GPS location and mapping are provided, which improves autonomous feature coverage and performance.

The feature data referred to herein may include feature data received at a host vehicle from other vehicles via vehicle-to-vehicle communication and/or vehicle-to-infrastructure communication. Historical feature data may be used for a same current route of travel of a host vehicle in the above-described examples. The historical feature data may be stored onboard and/or received from a remote server (e.g., a server at a back office, central office, and/or in a cloud-based network.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A LIDAR-to-vehicle alignment system comprising:
a memory configured to store points of data provided based on an output of a LIDAR sensor and global positioning system locations; and
an autonomous driving module configured to perform an alignment process comprising
obtaining the points of data,
performing feature extraction on the points of data to detect one or more features of one or more predetermined types of objects having one or more predetermined characteristics, wherein the one or more features are determined to correspond to one or more targets because the one or more features have the one or more predetermined characteristics, and
wherein one or more of the global positioning system locations are of the one or more targets,
determining ground-truth positions of the one or more features,
correcting the one or more of the global positioning system locations based on the ground-truth positions,
calculating a LIDAR-to-vehicle transform based on the corrected one or more of the global positioning system locations,
based on results of the alignment process, determining whether one or more alignment conditions are satisfied, and
in response to the LIDAR-to-vehicle transform not satisfying the one or more alignment conditions, recalibrating at least one of the LIDAR-to-vehicle transform or recalibrating the LIDAR sensor.

2. The LIDAR-to-vehicle alignment system of claim 1, wherein:
the autonomous driving module is configured to, while performing feature extraction, detect at least one of (i) a first object of a first predetermined type, (ii) a second object of a second predetermined type, or (ii) a third object of a third predetermined type; and
the first predetermined type is a traffic sign;
the second predetermined type is a light pole; and
the third predetermined type is a building.

3. The LIDAR-to-vehicle alignment system of claim 2, wherein the autonomous driving module is configured to, while performing feature extraction, detect an edge or a planar surface of the third object.

4. The LIDAR-to-vehicle alignment system of claim 1, wherein the autonomous driving module is configured to operate in an offline mode while performing the alignment process.

5. The LIDAR-to-vehicle alignment system of claim 1, wherein the autonomous driving module is configured to operate in an online mode while performing the alignment process.

6. The LIDAR-to-vehicle alignment system of claim 1, wherein the autonomous driving module is configured to, while performing feature extraction:
convert data from the LIDAR sensor to a vehicle coordinate system and then to a world coordinate system; and
aggregate resulting world coordinate system data to provide the points of data.

7. The LIDAR-to-vehicle alignment system of claim 1, wherein the autonomous driving module is configured to, while determining the ground-truth positions:
based on a vehicle speed, a type of acceleration maneuverer, and a global positioning system signal strength, assign weights to the points of data to indicate confidence levels in the points of data;
remove ones of the points of data having weight values less than a predetermined weight; and
determining a model of a feature corresponding to remaining ones of the points of data to generate the ground-truth data.

8. The LIDAR-to-vehicle alignment system of claim 7, wherein the model is of a plane or a line.

9. The LIDAR-to-vehicle alignment system of claim 7, wherein the ground-truth data includes the model, an eigenvector, and a mean vector.

10. The LIDAR-to-vehicle alignment system of claim 7, wherein the ground-truth data is determined using principal component analysis.

11. The LIDAR-to-vehicle alignment system of claim 1, wherein:
the LIDAR-to-vehicle alignment system is implemented at a vehicle;
the memory stores inertial measurement data; and
the autonomous driving module is configured to, during the alignment process,
based on the inertial measurement data, determine an orientation of the vehicle, and
correct the orientation based on the ground-truth data.

12. The LIDAR-to-vehicle alignment system of claim 1, wherein the autonomous driving module is configured to perform interpolation to correct the one or more of the global positioning system locations based on previously determined corrected global positioning system locations.

13. The LIDAR-to-vehicle alignment system of claim 1, wherein the autonomous driving module is configured to:
correct the one or more global positioning system locations using a ground-truth model for a traffic sign or a light pole;
project LIDAR points for the traffic sign or the light pole to a plane or a line;
calculate an average global positioning system offset for a plurality of timestamps;
apply the average global position system offset to provide the corrected one or more of the global positioning system locations; and
update a vehicle-to-world transform based on the corrected one or more of the global positioning system locations.

14. The LIDAR-to-vehicle alignment system of claim 1, wherein the autonomous driving module is configured to:
correct the one or more global positioning system locations and inertial measurement data using ground-truth point matching including
running a iterative closest point algorithm to find a transformation between current data and the ground-truth data,
calculating an average global positioning system offset and a vehicle orientation offset for a plurality of timestamps, and
applying the average global positioning system offset and the vehicle orientation offset to generate the corrected one or more of the global positioning system locations and a corrected vehicle orientation; and
update a vehicle-to-world transform based on the corrected one or more of the global positioning system locations and the corrected inertial measurement data.

15. A LIDAR-to-vehicle alignment process comprising:
obtaining points of data provided based on an output of a LIDAR sensor;
performing feature extraction on the points of data to detect one or more features of one or more predetermined types of objects having one or more predetermined characteristics, wherein the one or more features are determined to correspond to one or more targets because the one or more features have the one or more predetermined characteristics;
determining ground-truth positions of the one or more features;
correcting one or more global positioning system locations of the one or more targets based on the ground-truth positions;
calculating a LIDAR-to-vehicle transform based on the corrected one or more global positioning system locations;
based on results of the alignment process, determining whether one or more alignment conditions are satisfied; and
in response to the LIDAR-to-vehicle transform not satisfying the one or more alignment conditions, recalibrating at least one of the LIDAR-to-vehicle transform or recalibrating the LIDAR sensor.

16. The LIDAR-to-vehicle alignment process of claim 15, further comprising, while determining the ground-truth positions:
based on a vehicle speed, a type of acceleration maneuverer and a global positioning system signal strength, assigning weights to the points of data to indicate confidence levels in the points of data;
removing ones of the points of data having weight values less than a predetermined weight; and
determining a model of a feature corresponding to remaining ones of the points of data using principal component analysis to generate the ground truth-data, wherein the model is of a plane or a line, wherein the ground-truth data includes the model, an eigenvector, and a mean vector.

17. The LIDAR-to-vehicle alignment process of claim 15, further comprising:
based on inertial measurement data, determine an orientation of a vehicle; and
correct the orientation based on the ground-truth data.

18. The LIDAR-to-vehicle alignment process of claim 15, wherein the one or more global positioning system locations are corrected by implementing interpolation based on previously determined corrected global positioning system locations.

19. The LIDAR-to-vehicle alignment process of claim 15, further comprising:
correcting the one or more global positioning system locations using a ground-truth model for a traffic sign or a light pole;
projecting LIDAR points for the traffic sign or the light pole to a plane or a line;
calculating an average global positioning system offset for a plurality of timestamps;
applying the average global position system offset to provide the corrected one or more global positioning system locations; and
updating a vehicle-to-world transform based on the corrected one or more global positioning system locations.

20. The LIDAR-to-vehicle alignment process of claim 15, further comprising:
correcting the one or more global positioning system locations and inertial measurement data using ground-truth point matching including
running a iterative closest point algorithm to find a transformation between current data and the ground-truth data,
calculating an average global positioning system offset and a vehicle orientation offset for a plurality of timestamps, and
applying the average global positioning system offset and the vehicle orientation offset to generate the corrected one or more global positioning system locations and a corrected vehicle orientation; and
updating a vehicle-to-world transform based on the corrected one or more global positioning system locations and the corrected inertial measurement data.
